(19) United States
(12) Patent Application Publication
(10) Pub. No.: US 2025/0292310 A1
(43) Pub. Date: Sep. 18, 2025

(54) PERSONALIZED VIRTUAL ENVIRONMENT-BASED MARKETPLACES

(71) Applicant: International Business Machines Corporation, Armonk, NY (US)

(72) Inventors: Sarbajit K. Rakshit, Kolkata (IN); Sathya Santhar, CHENNAI (IN); Sridevi Kannan, Chennai (IN)

(21) Appl. No.: 18/603,838

(22) Filed: Mar. 13, 2024

(51) Int. Cl. G06Q 30/0601; G06Q 30/0201; G06T 19/00; H04L 67/50

(52) U.S. Cl. CPC G06Q 30/0643; G06Q 30/0201; G06T 19/006; H04L 67/535

(57) ABSTRACT

Techniques are described with respect to a system, method, and computer program product for constructing personalized virtual environment-based marketplaces. An associated method includes analyzing a plurality of user activity data associated with a user; aggregating the plurality of user activity data based on the analysis; and generating a virtual environment-based marketplace in accordance with the aggregation.

### BACKGROUND

This disclosure relates generally to computing systems and augmented reality, and more particularly to computing systems, computer-implemented methods, and computer program products configured to render personalized virtual environment-based marketplaces.

Internet-based commerce provides shoppers with the convenience of browsing and purchasing catalogues of products without having to enter a physical store. Virtual, augmented, mixed, and/or extended reality systems have expounded this concept by providing shoppers the ability to immerse themselves in a virtual environment that functions as a digital representation of a marketplace. However, shoppers generally have to navigate the virtual marketplaces in order to find products that align with their desires, which is generally a time consuming process that is counterintuitive to internet-based commerce altogether.

### SUMMARY

Additional aspects and/or advantages will be set forth in part in the description which follows and, in part, will be apparent from the description, or may be learned by practice of the invention.

A system, method, and computer program product for constructing personalized virtual environment-based marketplaces, the method comprising: analyzing a plurality of user activity data associated with a user; aggregating the plurality of user activity data based on the analysis; and generating a virtual environment-based marketplace in accordance with the aggregation.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment, according to an exemplary embodiment;

FIG. 2 illustrates a block diagram of a personalized virtual environment-based marketplace system environment, according to an exemplary embodiment;

FIG. 3 illustrates a block diagram of various modules associated with the personalized virtual environment-based marketplace system of FIG. 2, according to an exemplary embodiment;

FIG. 4 illustrates a virtual environment including a personalized virtual environment-based marketplace tailored to a user presented on a computing device, according to an exemplary embodiment; and

FIG. 5 illustrates an exemplary flowchart depicting a method for constructing a personalized virtual environment-based marketplace, according to an exemplary embodiment.

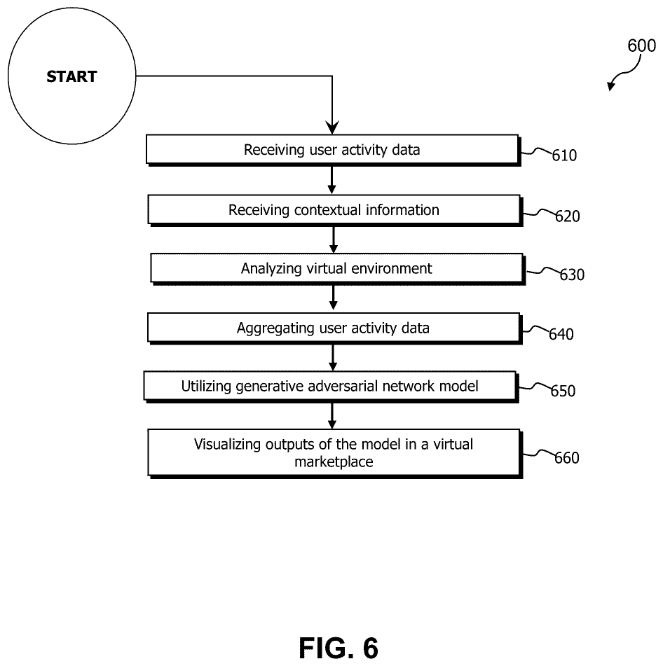

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program product for constructing personalized virtual environment-based marketplaces. Virtual, augmented, mixed, and/or extended reality systems may facilitate virtualized shopping experiences that support presentation of products tailored to the preferences of AR/VR users within virtual environments; however, said presentation still requires traversal by users through countless amounts of catalogues being offered by retailers offering products for consumers. Thus, the present embodiments have the capacity to personalize the virtual shopping experience for users by collecting and analyzing various sources of data associated with a user such as, but not limited to internet browsing history, search history, geographic location information, contextual information, and the like to construct a personalized virtual environment-based marketplace comprising products selected based on the aforementioned. In addition, the present embodiments utilize artificial intelligence technologies, such as but not limited to generative models to construct the virtual-environment based marketplace in a manner in which the marketplace is a multi-dimensional hierarchal shopping floor comprising a plurality of virtual stores selected corresponding to the analyzed aforementioned data. Furthermore, the constructed personalized marketplaces facilitate optimized user analytics due to the fact that patterns of usage, durations of usage, and aggregation of user activity of multiple users within a virtual environment in a manner that results in a personalized marketplace reflecting collaborative filtration of catalogues within the multi-dimensional hierarchal shopping floor comprising prioritized products; thus, preserving computing resources that would otherwise be needed to visualize the personalized marketplace within a virtual environment (e.g., GPU utilization, video random access memory (VRAM), and the like).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It is further understood that although this disclosure includes a detailed description on cloud-computing, implementation of the teachings recited herein are not limited to a cloud-computing environment. Rather, embodiments of the present invention are capable of being implemented in conjunction with any other type of computing environment now known or later developed.

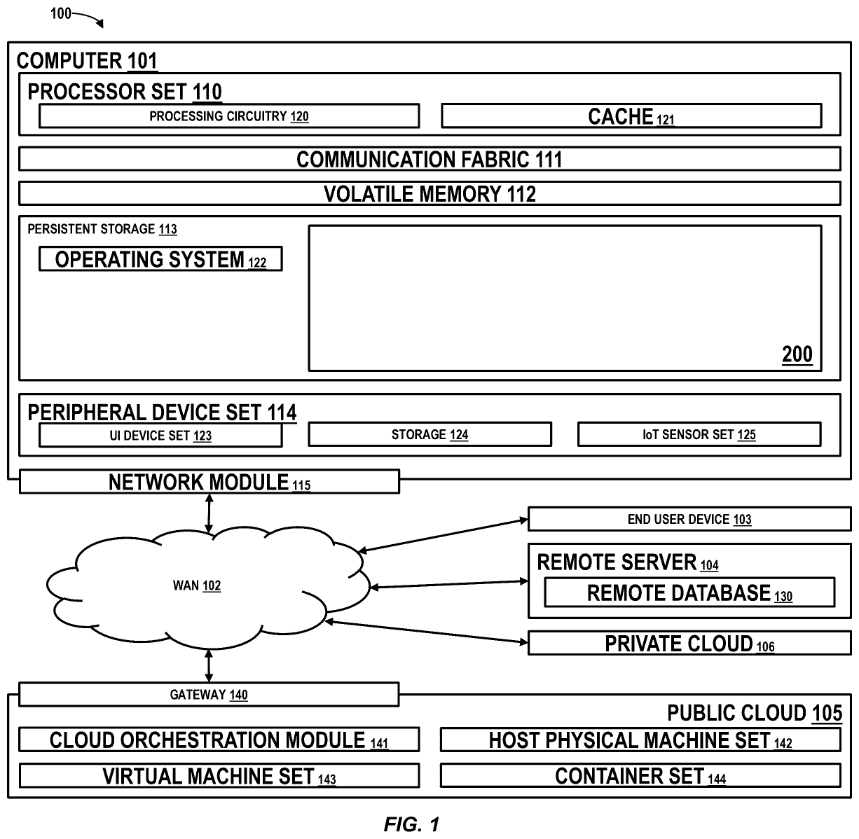

The following described exemplary embodiments provide a system, method, and computer program product for constructing personalized virtual environment-based marketplaces. Referring now to FIG. 1, a computing environment 100 contains an example of an environment for the execution of at least some of the computer code involved in performing the inventive methods, such as system 200. In addition to system 200, computing environment 100 contains an example of an environment for the execution of at least some of the computer code involved in performing the inventive methods. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, computer-mediated reality device (e.g., AR/VR headsets, AR/VR goggles, AR/VR glasses, etc.), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) payment device), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD payment device. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter payment device or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

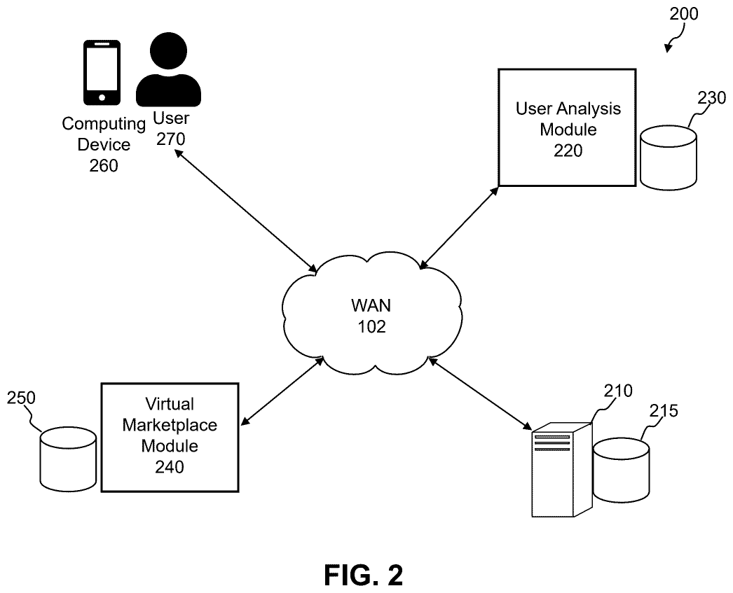

Referring now to FIG. 2, a functional block diagram of a networked computer environment illustrating a computing environment for a virtual environment-based obstacle manipulation system 200 (hereinafter “system”) comprising a server 210 communicatively coupled to a database 215, a user analysis module 220, a user analysis module database 230, a virtual marketplace module 240, a virtual marketplace module database 250, a computing device 260 associated with a user 270, each of which are communicatively coupled over WAN 102 (hereinafter “network”) and data from the components of system 200 transmitted across the network is stored in database 215.

In some embodiments, server 210 is tasked with providing a centralized platform configured to render personalized virtual environment-based marketplaces tailored for user 270 presented on computing device 260. It should be noted that the marketplace is a virtual environment comprising a multi-dimensional hierarchal shopping floor configured to be traversed by user 270; however, the multi-dimensional hierarchal shopping floor is continuously being updated and/or modified by system due to the fact that user activity associated with computing device 260 and/or user 270 is continuously being fed. Because of this, a first layout of the marketplace during a first session may comprise entirely different virtual stores compared to a second layout of the marketplace during a second session presented to user 270 on computing device 260. In some embodiments, server 210 may be communicatively coupled to one or more web crawlers configured to crawl applicable internet-based data sources in order to extract relevant data associated with user 270 including, but not limited to geographic location of user 270, contextual information, social media platforms, crowdsourcing platforms, and the like. For example, if the current weather associated with the geographic location of computing device 260 indicates that it is currently or soon will be raining, then the virtual marketplace may comprise one or more virtual stores offering rain boots, raincoats, etc. for purchase by user 270. Server 210 may further utilize one or more application programming interfaces (APIs) to provide the functionality to receive user inputs of user 270 for the purpose of receiving user preferences, configuration/design choices, user feedback, and the like. Data associated with computing device 260 and/or user 270 may be stored in user profiles housed in database 215, and various modules described herein may utilize one or more supervised and/or unsupervised learning techniques (e.g. feedback loops) processing datasets derived from database 215 in order to continuously optimize user preferences, configuration/design choices, user feedback, and the like and transmit results of the aforementioned to virtual marketplace module 240 in order to optimize the rendered personalized virtual marketplaces.

User analysis module 220 is tasked with analyzing data associated with user 270 including, but not limited to user browsing activity/history, virtual environment based analytics (e.g., amount of time spent in a virtual marketplace, amount of time spent in a particular virtual store, types of content (i.e., catalogues/products) interacted with the most, etc.), social media activity (e.g., posts, threads, comments, and the like interacted with), level of interactivity with chatbots/avatars, websites frequented, and any other applicable type of user information that indicates user consumption known to those of ordinary skill in the art. It should be noted that an immense amount of information relating to user 270 may be derived from user analysis module 220 processing the aforementioned data. For example, user analysis module 220 may consider how much time user 270 spends on different content patterns on browsed web pages and/or virtual environments and the navigation behavior of user 270, in which virtual marketplace module 240 the design of the virtual reality shopping floor will be created and will be identifying the places on the personalized virtual marketplace where promotional content is to be allocated. User analysis module 220 maintains the analyses of the aforementioned data in a user profile stored on user analysis module database 230, in which the user profile is continuously updated based on new data being received by computing device 260, user analysis module 220, and/or analyses performed on data within databases 215, user analysis module database 230, and virtual marketplace module database 250. In some embodiments, user analysis module 220 is configured to perform filtration of user activity data based on collaboration and/or ascertained contextual information associated with user 270 and/or the applicable virtual environment. For example, user analysis module 220 may ascertain based on analyzing browsing activity and linguistic inputs of user 270 that user 270 is in need of a pair of new shoes; however, contextual information indicates based off of the geographic location associated with computing device 260 there has been a lot of rain lately in the associated geographic region. Thus, user analysis module 220 is able to utilize the contextual information to filter out available shoe options for user 270 that would be heavily impacted by water/liquid damage (e.g., polyester shoes, suede shoes, and the like). Furthermore, user analysis module 220 is configured to perform aggregation of analyzed user activity data in order to render optimized metrics derived from the collaborative filtering, in which preferences of users with one or more similar interests, browsing activities, and the like are taken into consideration via a matching process based on characteristics associated with the products. As a result, virtual marketplace module 240 is able to utilize this information to render a virtual marketplace tailored to the preferences and browsing activities of user 270 comprising virtual stores that align with the aggregation of analyzed user activity data.

Virtual marketplace module 240 is tasked with performing analyses on virtual environments, aggregating analyzed user activity data, and rendering visualizations of the virtual marketplaces tailored to user 270. It should be noted that virtual marketplace module 240 may utilize generative models, such as but not limited to generative adversarial networks (GANs) and the like, utilizing training datasets derived from one or more of databases 215, user analysis module database 230, and virtual marketplace module database 250 to construct personalized virtual environment-based marketplaces. In some embodiments, a personalized virtual environment-based marketplace is a multi-dimensional hierarchal shopping floor comprising a plurality of virtual stores selected corresponding to the user activity data analyzed by user analysis module 220. It should be noted that virtual marketplace module 240 is configured to utilize one or more artificial intelligence-based techniques including, but not limited to computer vision systems, natural language processing (NLP), linguistics analysis, image analysis, topic identification, virtual object recognition, setting/environment classification, and any other applicable artificial intelligence and/or cognitive-based techniques known to those of ordinary skill in the art. Virtual marketplace module 240 is further configured to perform collaborative filtering which results in the preferences of virtual environment participants other than user 270 to be correlated to the preferences derived from the analyses of user activity data of user 270 in order to render recommendations of virtual stores and/or products to be presented within the personalized virtual marketplace. For example, if user activity data indicates that other shoppers preferred a particular product and/or frequently bought a second product with a first product (e.g., matching socks with a pair of shoes, soundbar with a display device, etc.). One of the purposes of virtual marketplace module 240 is to facilitate a collaborative experience for user 270 in which their activity history, interactions with virtual elements (e.g., avatar, chatbots, product catalogs, etc.), purchase history, and the like are analyzed in order to generate optimized metrics applied to the virtual marketplace experience. For example, analyzes performed historical catalogue interactions of user 270 may be used to designate which virtual stores are presented to user 270 within a given virtual marketplace. In another example, contextual information such as, but not limited to weather data, time range, supply chain shortage (i.e., both current and predicted), linguistic input analyses, etc. associated with user 270 may indicate that user 270 is in need of various products to endure the aforementioned, in which virtual stores comprising the catalogs that have products associated with the aforementioned are presented in the virtual marketplace. Virtual marketplace module database 250 stores the previously rendered virtual marketplace layouts (e.g., selected virtual stores, selected products, etc.) so that analytics and metrics can be ascertained based upon level of engagement, amount of time of engagement, etc. associated with user 270 and the previously rendered virtual marketplaces.

Computing device 260 may take the form of a desktop computer, laptop computer, tablet computer, smart phone, smart watch or other wearable computer, mainframe computer, computer-mediated reality (CMR) device/VR device, quantum computer or any other form of computer or mobile device now known or to be developed in the future that is capable of running a program, accessing a network, or querying a database. It should be noted that in the instance in which computing device 260 is a CMR device (e.g., VR headset, AR goggles, smart glasses, etc.) or other applicable wearable device, computing device 260 is configured to collect sensor data via one or more associated sensor systems including, but are not limited to, cameras, microphones, position sensors, gyroscopes, accelerometers, pressure sensors, cameras, microphones, temperature sensors, biological-based sensors (e.g., heartrate, biometric signals, etc.), a bar code scanner, an RFID scanner, an infrared camera, a forward-looking infrared (FLIR) camera for heat detection, a time-of-flight camera for measuring distance, a LaDAR sensor, a LiDAR sensor, a temperature sensor, a humidity sensor, a motion sensor, internet-of-things (“IoT”) sensors, or any other applicable type of sensors known to those of ordinary skill in the art.

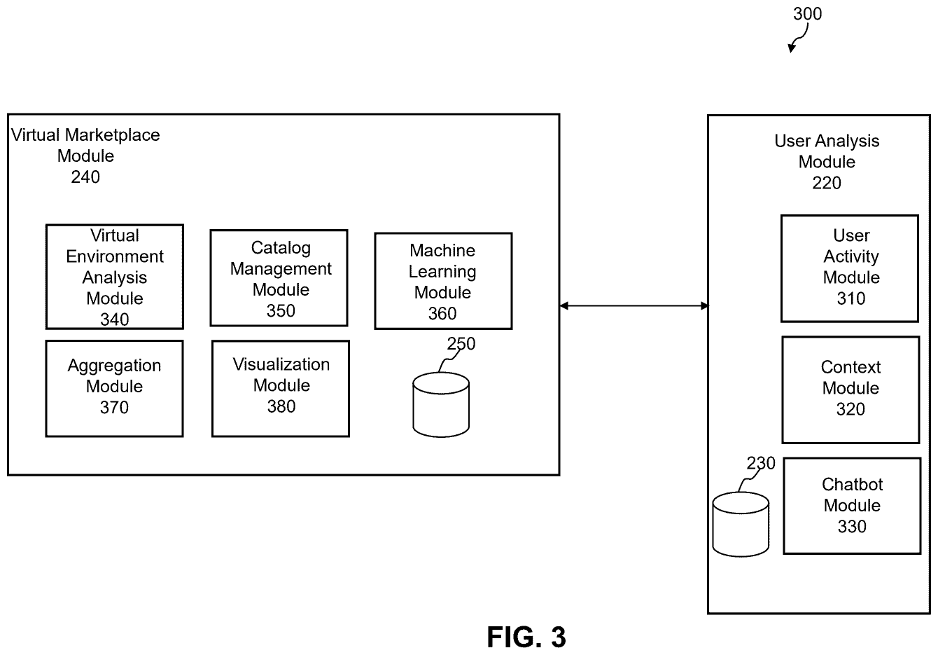

Referring now to FIG. 3, an example architecture 300 of user analysis module 220 and virtual marketplace module 240 is depicted, according to an exemplary embodiment. User analysis module 220 comprises user activity module 310, context module 320, and chatbot module 330. Virtual marketplace module 240 comprises virtual environment analysis module 340, catalog management module 350, machine learning module 360, aggregation module 370, and visualization module 380. It should be noted that user analysis module 220 and virtual marketplace module 240 are communicatively coupled over the network allowing for outputs and/or analyses performed by each respective module to be utilized in applicable training datasets to be utilized by applicable machine learning models operated by machine learning module 360 and/or applicable cognitive systems associated with system 200.

User activity module 310 is tasked with collecting and analyzing data associated with computing device 260 and/or user 270 in order for various data relating to user 270 to be ascertained such as, but not limited to user internet browsing activity, user shopping trends, spending/consuming patterns, social media activity (e.g., posts, likes, advertisement interest, etc.), eating habits, sleeping habits, advertisement preferences, AR/VR visualization preferences, and any other ascertainable pattern/trend-related data associated with a user known to those of ordinary skill in the art. It should be noted that various mechanisms may be utilized in order to ascertain the aforementioned data including, but not limited to fingerprinting (i.e., analyzing current and future trends/needs associated with user 270), relationship/connection/interaction analyzing across social media platforms, search history analysis, and the like. For example, user activity module 310 collects data from online sources as well as from the users' web activity on computing device 260, which may include but is not limited to active time of day, pages visited, web browsers identified, applications accessed, as well as local contents present in the web browser, virtual environment (e.g., virtual marketplace), etc. In some embodiment, user activity module 310 transmits aggregations of online user activity as user data-based training datasets to virtual marketplace module 240. User data may also be derived from user traffic data ascertained from advertisement cohorts, commercial data brokers, proxy servers, proxy harvesting, tor exit nodes, query searches, application usage, or the aforementioned web crawlers associated with server 210. User activity module 310 is further configured to ascertain from the collected user data affinities and dislikes of user 270 based on analyses of not only ascertained user data, but also analyses of applicable sensor data derived from computing device 260. For example, if user 270 expresses a particular facial reaction towards a product depicted within a virtual marketplace, then user activity module 310 is able to utilize electromyography (EMG), diagnostic and analysis techniques for evaluating and recording electrical activity produced by muscle tissue of user 270, to determine that user 270 dislikes the product. In some embodiments, user activity module 310 may identify activities associated with shopping cycles of user 270 based on one or more of historical patterns within physical and/or virtual stores, biometric data of user 270 (e.g., heartrate, eye gazing movements, non-rapid eye-movement (NREM)/rapid eye-movement (REM), etc.), schedules/calendars of user 270, health conditions of user 270, budget data, weather data, traffic/road conditions data, and the like.

Context module 320 is tasked with ascertaining contextual information associated with the user activity data collected and analyzed by user activity module 310. In some embodiments, context module 320 is configured to utilize natural language processing (“NLP”)/linguistics processing, image/media recognition, object recognition, predictive analytics, behavioral classification techniques, and the like in order to establish a context associated with user activity data associated with user 270 including, but not limited to time, location, duration of usage, sentiment, and any other contextual related information known to those of ordinary skill in the art. Contextual information may further comprise time-stamped temporal information associated with activities of user 270 with virtual stores, products of virtual stores, internet-based sources, other users and entities within virtual/augmented reality-based environments (e.g., avatars, chatbots, etc.), advertisements/promotions, and the like. For example, context module 320 may analyze the aforementioned in order to ascertain various factors such as current weather, relevant consumer activity, product supply-chain, inventory location, virtual store activity, etc., in which contextual information is utilized by virtual marketplace module 240 in order to organize construction a virtual marketplace tailored for user 270. For example, analyses of linguistic inputs of user 270 may indicate that user 270 is in need of a new jacket in light of an upcoming cold-front predicted by weather analysis (i.e., derived from weather data ascertained by the web crawlers), in which context module 320 ascertains that the upcoming supply of high-quality winter jackets is predicted to be low. As a result, virtual marketplace module 240 constructs the virtual marketplace with a plurality of virtual stores displaying promotions associated with available high-quality winter jackets. It should be noted that the virtual stores presented within a customized virtual marketplace are configured to serve as digital simulations of physical stores and/or e-commerce sources offering products for consumption. Contextual information is continuously refined via one or more feedback loops operated by the applicable module(s) of virtual marketplace module 240 in order to optimize the selection of virtual stores and visualized products for consumption within the virtual marketplace in real-time. In some embodiments, contextual information may be utilized to map physical stores within proximity to the detected location of computing device 260, in which context module 320 interacts with one or more GANs in order to visualize a virtual store representing a mapped physical store within the virtual marketplace, in which the available catalogs of the physical store are based on data ascertained by the web crawlers and/or applicable third party server.

Chatbot module 330 is designed to ascertain data associated with the interactions of user 270 with chatbots within virtual environments and any other applicable virtual elements known to those of ordinary skill in the art. In addition, chatbot module 330 is configured to generate and manage a virtual marketplace chatbot configured to be presented in the virtual marketplace as an interactive avatar designed to be aligned with the browsing histories associated with user 270 derived from analyses performed by user activity module 310. It should be noted that chatbot interactions with the virtual marketplace chatbot may provide various types of data related to virtual marketplace engagement. For example, chatbots, virtual assistants, and the like presented within virtual environments may allow user 270 to provide interactions that facilitate filtration of virtual marketplace visualized content and ultimately the purpose as to why user 270 is in a virtual marketplace. Chatbots may facilitate interactive questions relating to how user 270 is feeling, purpose in engaging with the generated virtual marketplace, what user 270 is looking for, how often does user 270 want to visit virtual marketplaces/optimize their virtual marketplace experience, and the like. Chatbot interactions may also assist with selection of promotional content that is presented within the virtual marketplace, in which engagement by user 270 may result in alteration of the virtual stores depicted within the virtual marketplace in real-time. For example, one or more interactions between user 270 and the applicable chatbot(s) may result in an update of not only virtual stores depicted, but also an update in the available catalogs of products available for purchase of the respective virtual stores. In some embodiments, chatbot module 330 utilizes a recurrent neural network (RNN) to generate and transduce assistance-based dialogues between the applicable chatbot(s) and user 270, and a Convolutional Neural Network (CNN) process and correlate applicable contextual information ascertained from the dialogues to catalogs and products associated with virtual stores ultimately visualized within the generated virtual marketplaces.

Virtual environment analysis module 340 is tasked with analyzing virtual marketplaces generated by GANs for the purpose of optimizing subsequent visualizations of virtual marketplaces generated for user 270. Virtual environment analysis module 340 is further configured to perform analyses of virtual environments in order to ascertain virtual elements such as virtual objects, virtual environment themes, patterns, avatars, virtual agents, factors associated with computing device 260 such as but not limited to physical surroundings (e.g., architectures, time periods/time of day, etc.), geographic location, linguistic inputs, speech patterns, gestures, and the like for the purpose of optimizing virtual marketplaces presented to user 270. It should be noted that virtual environment analysis module 340 may utilize image/video analysis, parsing, tokenizing, 3D point cloud segmentation, virtual object detection, theme identification, or any other applicable VR/AR-based analysis mechanisms known to those of ordinary skill in the art. In some embodiments, virtual environment analysis module 340 analyzes the navigation path of user 270 within generated virtual marketplaces in order to not only enhance the virtual marketplace experience, but also ascertain e-commerce shopping habits, personal information, demographic data (e.g., interests, language, level of education, etc.), and the like associated with user 270 in real-time. For example, demographic data associated with user 270 may not be ascertainable via their activities being analyzed by user activity module 310; however, it may be ascertained by virtual environment analysis module 340 due to the nature and type of virtual elements being interacted with by user 270 within virtual environments (e.g., user 270 is in a relationship based on interactions with virtual stores offering promotions for engagement rings, etc.).

Catalog management module 350 is tasked with supervising the types of content (i.e., catalogs and products thereof) that are depicted within virtual stores visualized within a virtual marketplace. In some embodiments, catalog management module 350 is configured to perform scoring of catalogs and products of catalogs based on generating a virtual marketplace threshold, in which the respective catalogs and products of catalogs exceeding the virtual marketplace threshold results in the aforementioned being selected for visualization within their respective virtual stores in the generated virtual marketplace. The virtual marketplace threshold is based on one or more of analyses derived from user activity module 310, ascertained contextual information, chatbot interactions derived from chatbot module 330, and/one or more outputs of machine learning module 350. Furthermore, promotional content allocation within a generated virtual environment may be determined by catalog management module 350, in which the navigation behavior of user 270 dictates the placement of promotional content proximate to visualizations associated with the virtual stores. For example, if it is determined that user 270 typically browses for shoes subsequent to shopping for clothing garments then catalog management module 350 will visualize promotional content for shoes proximate to the depictions of clothing garments associated with the applicable virtual stores.

Machine learning module 360 is configured to use one or more heuristics and/or machine learning models for performing one or more of the various aspects as described herein (including, in various embodiments, the natural language processing or image analysis discussed herein). In some embodiments, the machine learning models may be implemented using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are considered to be within the scope of this disclosure. For example, machine learning module 360 is designed to maintain one or more machine learning models dealing with training datasets including data derived from one or more of database 215, user analysis module database 230, virtual marketplace module database 250, and any other applicable internet-based data source. Furthermore, the one or more machine learning models are designed to generate outputs representing predictions pertaining to user activity, user shopping trends, promotional content allocation within virtual marketplaces, catalog and product selection/visualization, and the like. For example, GANs utilize a generator and discriminator in order to render a virtual marketplace customized for user 270 based on conditional inputs comprising one or more user preferences, catalog/product suggestions, contextual information, and the like. Subsequently, the outputs of the GAN are transmitted to visualization module 380 in order to depict the customized virtual marketplace on computing device 260. In some embodiments, the generator generates synthetic data samples by mapping random noise vectors or conditional inputs, such as user preferences, catalog/product suggestions, and contextual information, to meaningful data representations. Concurrently, the discriminator evaluates the authenticity of these synthetic samples by distinguishing between real and fake data, providing feedback to the generator to improve its output. This iterative process of adversarial training enables the generator to continually refine its output to generate more realistic data samples. For rendering a virtual marketplace customized for user 270, GANs utilize conditional inputs to tailor the generated content to individual preferences and requirements. These inputs may encompass a wide range of factors, including user demographics, past purchase history, browsing behavior, and contextual cues. Data augmentation, regularization, and hyperparameter tuning play crucial roles in optimizing the performance and robustness of the GAN-based virtual marketplace system. Instead of training a GAN and then filtering the outputs based on user preferences, cGAN (Conditional GAN) is used here to condition the output based on controlling attributes in the input. Both the generator and discriminator present a non-linear mapping function over input dataset x. The parameters of both the generator and discriminator are adjusted in a manner in which the loss function is minimized with the output getting closer to the expected conditioned sets through multiple iterations. Once the virtual marketplace is generated, based on purchase behaviors of user 270 in the new environment, the feedback is taken into account for future generation of virtual marketplaces for other users. The feedback is a controlled loop acting as a conditioning attribute for other users.

Aggregation module 370 is tasked with performing aggregation of browsing history, navigation paths, and other applicable data derived from analyses of user activity associated with user 270. It should be noted that one of the purposes of aggregating user activity data is to facilitate scalable generation of multitudes of virtual marketplaces for user 270 in a manner that reduces the amount of computing resources otherwise necessary. In some embodiments, aggregation module 370 performs filtering of the user activity data during the aggregation process, in which the user activity data is filtered based on one or more derivatives of the analyses of the contextual information. This allows aggregation module 370 to tag/annotate browsing histories with various metadata including, but no limited to access privileges, classifications (e.g., travel browsing history, fitness browsing history, etc.), catalogs/products highly recommended to user 270 and associates, and the like. For example, access privileges allocated to a particular browsing history associated user 270 allows gatekeeping of which individuals the multi-dimensional hierarchal shopping floor is shared with and/or allocation of specific levels of a virtual marketplace to specific individuals (e.g. travel colleagues of user 270 do not have access to a level of virtual stores that education colleagues have access to). As a result of the aggregation and filtration, voluminous amounts of data relating to the plurality of browsing histories, navigation paths, etc. associated with user 270 are accessible based on the generated metadata that serves a reference, partitioned, and stored in virtual integration module database 250 allowing previously rendered correlated virtual marketplaces (e.g., catalogs and products of previously rendered virtual marketplaces that align with analyzed user activities) to be accessed in a manner that reduces the amount computing resources otherwise needed to re-render virtual marketplaces upon request. In some embodiments, aggregation module 370 utilizes an aggregation model to perform the aforementioned, in which deep neural networks are utilized to establish the correlations between the user activities and the catalogs and products selected for visualization within the customized virtual marketplace. In some embodiments, aggregation module 370 is configured to support user 270 selecting different sections of the browsing history and based on aggregated browsing history generate virtual marketplaces accordingly. For example, user 270 may select a browsing history for a specific purposes (e.g., browsing session for traveling plans), in which a customized virtual marketplace comprising a plurality of virtual stores related to the selected browsing history. Furthermore, aggregation of browsing history allows for identification of entities, catalogs, and products associated with the browsing histories, in which aggregation module 370 allows a group experience for user 270 configured to provide a virtual marketplace for user 270 to share with family, friends, connections, etc. Thus, a virtual marketplace comprising a multi-dimensional hierarchal shopping floor having a plurality of virtual stores selected corresponding to the analyzed user activity data associated with user 270 is available and shareable for parties desired by user 270 in real-time. For example, colleagues that user 270 frequently travels with are provided the same shopping floor to simultaneously view the same catalogs and products based upon the applicable browsing history selected by user 270.

Visualization module 380 is tasked with rendering and depicting the virtual marketplaces. Visualization module 380 utilizes GANs and/or any other applicable VR/AR content mechanisms configured to support dynamic virtual content generation/modification, in which the virtual marketplaces are multi-dimensional hierarchal shopping floors comprising a plurality of virtual stores selected by catalog management module 350 based on one or more of analyzed user activity, ascertained contextual information, and outputs of machine learning module 360. For example, GANs are utilized to generate visualizations of an augmented reality-based virtual space comprising one or more volumetric videos, holographic projections, and any other applicable type of multi-media content configured to be depicted within virtual environments known to those of ordinary skill in the art, in which the virtual space comprises products of catalogs selected based on the analyses off user activity data. As a result, an avatar representing user 270 is able to traverse the multi-dimensional shopping floors that the virtual marketplace consists of. Furthermore, visualization module 380 is configured to continuously analyze the tagged/annotated metadata of the browsing histories in order to select and visualize virtual stores generated within realistic virtual content that is aligned with background lighting, the virtual environment, and the like based on the ascertained contextual information. For example, user 270 may traverse the virtual marketplace and utter the statement “I just realized that I need to go grocery shopping”, in which instructions are executed for visualization module 380 to render at least one shopping floor of the multi-dimensional hierarchal shopping floors comprising virtual stores offering groceries based on one or more analyses of the aforementioned linguistic input.

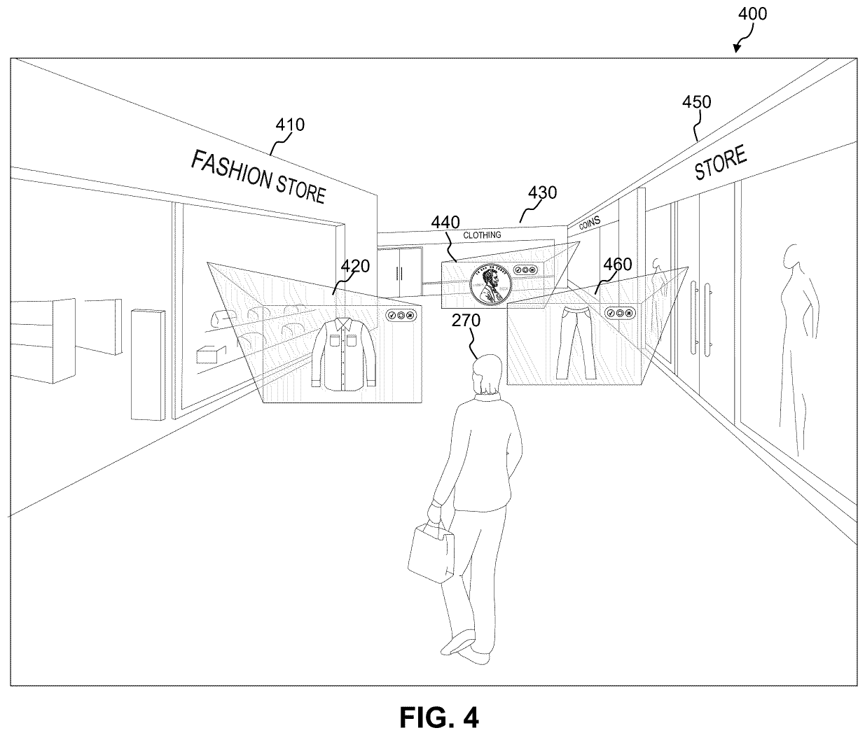

Referring to FIG. 4, a virtual marketplace 400 is depicted, according to an exemplary embodiment. It should be noted that virtual marketplace 400 is rendered by visualization module 380 based on analyses of one or more of user activity data, ascertained contextual information, browsing histories/sessions, and the like associated with user 270. As depicted, virtual marketplace 400 comprises virtual stores 410, 430, and 450, in which virtual stores 410, 430, and 450 comprise products 420, 440, and 460, respectively. In some embodiments, virtual stores 410, 430, and 450 along with products 420, 440, and 460 are selected based upon not only analyses of the user activity data, but also the ascertained contextual information associated with user 270. For example, user 270 traversing the virtual marketplace could have initially needed a shirt; however upon browsing through the catalog associated with virtual store 410 and finding product 420, user 270 utters “I think I need some pants to match this shirt”. As a result, catalog management module 350 selects virtual store 450 comprising product 460 based on analysis of the aforementioned linguistic input in addition to outputs of machine learning module 360 indicating that product 460 are pants that align with not only the aesthetics of product 420, but also the preferences of user 270 (e.g., size, design, material, etc.). Thus, visualization module 380 utilizes a GAN to visualize virtual store 450 comprising product 460 proximate to virtual store 410 within virtual marketplace 400. In some embodiments, product 440 is an advertisement presented proximate to user 270 in which if user engages with product 440 then access to virtual store 430 is activated resulting user 270 being able to toggle through the applicable catalog. It should be noted that shading, highlighting, flashing, illuminating, and any other applicable visual virtual environment effects triggered by user interactions (e.g., gestures, eye gazing, voice commands, etc.) known to those of ordinary skill in the art are designed to be applied to virtual stores, catalogs, products, applicable virtual elements, and the like.

With the foregoing overview of the example architecture, it may be helpful now to consider a high-level discussion of an example process. FIG. 6 depicts a flowchart illustrating a computer-implemented process 600 for virtual environment-based obstacle manipulation, consistent with an illustrative embodiment. Process 600 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 610 of process 600, user activity module 310 receives user activity data associated with user 270. As previously mentioned, user activity data includes, but is not limited to sensor data derived from computing device 260 (e.g., personal information, biological data, behavioral data, gestures/movements, etc.), shopping behavior, psychographic data, social media-based data, user analytics (e.g., user preferences, web activity patterns, search histories, etc.), and the like. In some embodiments, collected user activity data is stored in a user profile associated with user 270 which is continuously updated with data derived from server 210, user analysis module 220, virtual marketplace module 240. For example, machine learning module 360 may generate outputs which are predictions related to user preferences, catalog suggestions, product placement, etc. associated with user 270 based on activity data derived from the user profile.

At step 620 of process 600, context module 320 receives, analyzes, and/or generates contextual information associated with user 270. In particular, context module 320 analyzes data within the user profile, databases 215, user analysis module database 230, and/or virtual marketplace module database 250 in to establish a context associated with user activity data including, but not limited to time, location, duration of usage, sentiment, preferences, product aversion, catalog attraction, and any other contextual related information known to those of ordinary skill in the art. Contextual information may further comprise time-stamped temporal information associated with activities of user 270 with hierarchies of the virtual marketplace, browsing of virtual stores, interactions with catalogs/products of virtual stores, internet-based sources, other users and entities within virtual/augmented reality-based environments (e.g., avatars, chatbots, etc.), advertisements/promotions, and the like.

At step 630 of process 600, virtual environment analysis module 340 analyzes the virtual environment associated with user 270. One of the purposes of the virtual environment analyses is to ascertain virtual elements such as virtual objects, virtual environment themes, patterns, avatars, virtual agents/chatbots, factors associated with computing device 260 such as but not limited to physical surroundings (e.g., architectures, time periods/time of day, etc.), geographic location, linguistic inputs, speech patterns, gestures, and the like. This information may be useful for tailoring the configurations and visualizations of the virtual marketplace specifically for user 270 along with virtual elements within the virtual marketplace. For example, the analyses of the virtual environment may result in generation of virtual marketplace chatbots configured to provide support within the virtual marketplace as interactive avatars designed to correlate the browsing histories with preferences, desires, catalogs of interest, etc. associated with user 270. Virtual environment analysis also optimizes the visualization process for the virtual marketplace due to the fact that virtual environment analysis module 340 communicates with machine learning module 360 to instruct the GANs to utilize conditional inputs in order to tailor the generated content to individual preferences and requirements. Although these inputs can encompass a wide range of factors, including, but not limited to user demographics, past purchase history, browsing behavior, and contextual cues; the virtual elements-related data derived from the virtual environment analyses supports data augmentation, regularization, and hyperparameter tuning. These features play crucial roles in optimizing the performance and robustness of the GAN-based virtual marketplace system when rendered for visualization.

At step 640 of process 600, aggregation module 370 performs aggregation of the user activity data. Aggregation of the user activity data allows for filtering of the user activity data, in which the user activity data is filtered based on one or more derivatives of the analyses of the contextual information. This allows aggregation module 370 to tag/annotate browsing histories with various metadata including, but no limited to access privileges, classifications (e.g., travel browsing history, fitness browsing history, etc.), catalogs/products highly recommended to user 270 and associates, and the like. A hierarchy can be established for the user activity data due to the filtration and classification of user activity data as relevant or not relevant to the underlying purpose of traversing the virtual marketplace for user 270. For example, if it is ascertain that user 270 is traversing the virtual marketplace for a particular purpose, then chatbots, catalogs, and the like not relevant are filtered out through the process.

At step 650 of process 600, machine learning module 360 utilizes GANs generative model to construct the virtual-environment based marketplace. In some embodiments, the generative model is utilized to correlate and correspond the analyzed user activity data to a virtual marketplace comprising a virtual environment with virtual stores and catalogs related to the analyzed user activity data. The model is used to generate synthetic data samples by mapping random noise vectors or conditional inputs to meaningful data representations, and evaluate the authenticity of these synthetic samples by distinguishing between real and fake data. This results in continuous refining of outputs to generate more realistic data samples.

At step 660 of process 600, visualization module 380 visualizes outputs of the generative model in a virtual marketplace. In particular, visualization module 380 utilizes GANs and/or any other applicable VR/AR content mechanisms configured to support dynamic virtual content generation/modification, in which the virtual marketplaces are multi-dimensional hierarchal shopping floors. The visualization process involves visualization module 380 mapping the generated data onto graphical representations that accurately depict the virtual marketplace, comprising product listings, interactive user interfaces, interactive elements, and contextual details associated with both the virtual marketplace and catalogs within. User 270 is able to traverse the virtual marketplace interacting with virtual stores, catalogs, and other applicable users within the virtual marketplaces, in which hierarchies of the shopping floors of the virtual marketplace may designated for particular users associated with user 270 based on contextual information (e.g., education colleagues of user 270 having access to a first shopping floor comprising related virtual stores and social colleagues of user 270 only having access to a second shopping floor comprising virtual stores that both them and user 270 share interests for).

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-payment devices or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g. light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter payment device or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for constructing personalized virtual environment-based marketplaces, the method comprising:
analyzing, by a computing device, a plurality of user activity data associated with a user;
aggregating, by the computing device, the plurality of user activity data based on the analysis; and
generating, by the computing device, a virtual environment-based marketplace in accordance with the aggregation.

2. The computer-implemented method of claim 1, wherein analyzing comprises determining a plurality of contextual information associated with the user.

3. The computer-implemented method of claim 1, wherein the user activity data comprises one or more of browsing history of the user, time range, relevant shopper activity, duration of usage, chatbot interactivity metric, or combination thereof.

4. The computer-implemented method of claim 1, wherein aggregating comprises:
determining, by the computing device, an amount of time and a type of content associated with the user interacting within the virtual environment-based marketplace in order to optimize the generation of the virtual environment-based marketplace.

5. The computer-implemented method of claim 1, wherein generating a virtual-environment based marketplace comprises:
utilizing, by the computing device, a generative model to construct the virtual-environment based marketplace wherein the marketplace is a multi-dimensional hierarchal shopping floor comprising a plurality of virtual stores selected corresponding to the analyzed user activity data.

6. The computer-implemented method of claim 2, wherein aggregating comprises:
filtering, by the computing device, the user activity data based on an analysis of the plurality of contextual information;
wherein the filtering comprises tagging, by the computing device, the user activity data with access privilege metadata based on the analysis of the plurality of contextual information.

7. The computer-implemented method of claim 1, wherein the virtual environment-based marketplace is a visualization of an augmented reality-based virtual space comprising one or more holographic projection of products related to the user activity data configured to be traversed by an avatar representing the user.

8. A computer program product for constructing personalized virtual environment-based marketplaces, the computer program product comprising or more computer readable storage media and program instructions collectively stored on the one or more computer readable storage media, the stored program instructions comprising:
program instructions to analyze a plurality of user activity data associated with a user;
program instructions to aggregate the plurality of user activity data based on the analysis; and
program instructions to generate a virtual environment-based marketplace in accordance with the aggregation.

9. The computer program product of claim 8, wherein program instructions to analyze comprise:
program instructions to determine a plurality of contextual information associated with the user.

10. The computer program product of claim 8, wherein the user activity data comprises one or more of browsing history of the user, time range, relevant shopper activity, duration of usage, chatbot interactivity metric, or combination thereof.

11. The computer program product of claim 8, wherein program instructions to aggregate comprise:
program instructions to determine an amount of time and a type of content associated with the user interacting within the virtual environment-based marketplace in order to optimize the generation of the virtual environment-based marketplace.

12. The computer program product of claim 8, wherein program instructions to generate comprise:
program instructions to utilize a generative model to construct the virtual-environment based marketplace wherein the marketplace is a multi-dimensional hierarchal shopping floor comprising a plurality of virtual stores selected corresponding to the analyzed user activity data.

13. The computer program product of claim 9, wherein program instructions to aggregate comprise:
program instructions to filter the user activity data based on an analysis of the plurality of contextual information;
wherein the program instructions to filter comprise:
program instructions to tag the user activity data with access privilege metadata based on the analysis of the plurality of contextual information.

14. The computer program product of claim 9, wherein the virtual environment-based marketplace is a visualization of an augmented reality-based virtual space comprising one or more holographic projection of products related to the user activity data configured to be traversed by an avatar representing the user.

15. A computer system for constructing personalized virtual environment-based marketplaces, the computer system comprising:
one or more processors;
one or more computer-readable memories;
program instructions stored on at least one of the one or more computer-readable memories for execution by at least one of the one or more processors, the program instructions comprising:
program instructions to analyze a plurality of user activity data associated with a user;
program instructions to aggregate the plurality of user activity data based on the analysis; and
program instructions to generate a virtual environment-based marketplace in accordance with the aggregation.

16. The computer system of claim 15, wherein program instructions to analyze comprise:
program instructions to determine a plurality of contextual information associated with the user.

17. The computer system of claim 15, wherein program instructions to aggregate comprise:
program instructions to determine an amount of time and a type of content associated with the user interacting within the virtual environment-based marketplace in order to optimize the generation of the virtual environment-based marketplace.

18. The computer system of claim 15, wherein program instructions to generate comprise:
program instructions to utilize a generative model to construct the virtual-environment based marketplace wherein the marketplace is a multi-dimensional hierarchal shopping floor comprising a plurality of virtual stores selected corresponding to the analyzed user activity data.

19. The computer system of claim 16, wherein program instructions to aggregate comprise:
program instructions to filter the user activity data based on an analysis of the plurality of contextual information;
wherein the program instructions to filter comprise:
program instructions to tag the user activity data with access privilege metadata based on the analysis of the plurality of contextual information.

20. The computer system of claim 15, wherein the virtual environment-based marketplace is a visualization of an augmented reality-based virtual space comprising one or more holographic projection of products related to the user activity data configured to be traversed by an avatar representing the user.
